(19) United States
(12) Patent Application Publication
(10) Pub. No.: US 2014/0375779 A1
(43) Pub. Date: Dec. 25, 2014

(54) Method for Measuring Recognition Warping about a Three-Dimensional Image

(71) Applicant: Catholic University Industry Academic Cooperation Foundation, Seoul (KR)

(72) Inventor: Hang-Bong Kang, Seoul (KR)

(21) Appl. No.: 14/483,342

(22) Filed: Sep. 11, 2014

Related U.S. Application Data
(63) Continuation of application No. PCT/KR2012/001946, filed on Mar. 19, 2012.

(51) Int. Cl. H04N 17/00; G06T 3/00; H04N 13/00

(52) U.S. Cl. CPC H04N 17/004; H04N 13/0007; G06T 3/0093; H04N 2013/0074; G06T 2200/04
USPC 348/51

(57) ABSTRACT

The invention relates to a method for measuring recognition warping with respect to a three-dimensional (3D) image. The method according to the invention comprises: (a) a step of selecting any one from a plurality of 3D parameters for a scale for recognizing a 3D image in a 3D manner; (b) a step of displaying a test stereoscopic image corresponding to the selected 3D parameter on a screen; (c) a step of displaying, on a screen, a plurality of sample images obtained by varying the value of the selected 3D parameter for the test stereoscopic image; (d) a step of selecting at least one of the plurality of sample images; and (e) a step of performing the steps (b) to (d) at least two times on different test stereoscopic images, and measuring a 3D recognition scale for the selected 3D parameter based on the sample image selected in the step (d). Therefore, it is possible to measure whether a viewer distortedly recognizes a 3D image or the degree to which a viewer recognizes the 3D image three-dimensionally in connection with the 3D parameter such as the size of the 3D image, the depth of the 3D image, etc. by means of the 3D recognition ability of each viewer.

### PRIORITY

This application is a continuation of pending International Application No. PCT/KR2012/001946 filed Mar. 19, 2012, which designates the United States and claims priority to Korean Patent Application No. 10-2012-0024939 filed Mar. 12, 2012.

### TECHNICAL FIELD

The present invention relates to a method for measuring recognition warping about a three-dimensional (3D) image and, in particular, to a method for determining whether a viewer recognizes a distorted 3D image or for determining the degree to which a viewer recognizes the 3D image three-dimensionally with regard to the 3D parameter such as the size of the 3D image, the depth of the 3D image, etc.

### BACKGROUND ART

When a two-dimensional image is made to be recognized as a three-dimensional image, viewers may feel uncomfortable or be provided with various distortions due to the problems of the three-dimensional display itself or contents, the difference of the degree to which an individual recognizes a 3D image, watching environments, etc.

There is no distortion or discomfort in the real three-dimensional environment, regardless of objects to be watched, a visual point, surrounding, etc. But, in case of artificial 3D contents, the depth or shape can be distorted due to the various factors as described above.

Therefore, for the viewer's proper watching of various 3D contents, it is necessary to measure viewer's stereoscopic recognition ability accurately. However, there is no existing method for determining whether viewers recognize the size, shape and location of the three-dimensional object in contents without distortion or warp.

As stereovision method being used now, there are a stereo-acuity test such as a stereo fly test and a random dot stereo-acuity test. In this test, a fast response indicates good stereovision and a hint is provided for the 3D recognition when necessary. Mostly, polarizing glasses are used for the test, but polarizing glasses are not used in some stereovision tests.

In frisby stereotest, no polarizing glasses are needed and arrows which are arranged randomly are provided. From different arrow images arranged randomly, a viewer selects one which is recognized three-dimensionally and the distance is varied on this test. However, this test provides only whether a viewer recognizes an object three-dimensionally.

Korean laid-open patent publication No. 2010-0104328 suggests a technique to measure the distortion or warp of the 3D depth or the 3D shape systematically and quantitatively based on the viewer's orientation. But, this publication does not consider the difference of individual's ability with regard to 3D recognition.

To determine whether a viewer recognizes 3D contents in the movie or TV properly, a system is required to evaluate the distortion of 3D object and the reality such as a depth or a size of 3D object which a viewer recognizes. The distortion and the reality for the 3D contents are determined depending on whether the size, shape and location of the 3D object are recognized accurately. Since the distortion and the reality depend on an individual, the viewer's recognition warping with regard to the 3D object will be tested by measuring the size, shape and location which an individual recognizes and by comparing it to the accurate ground truth.

### DISCLOSURE OF THE INVENTION

### Technical Problem

An object of the present invention is to solve the above problems and in particular to provide a method for measuring whether a viewer distortedly recognizes a three-dimensional (3D) image or the degree to which a viewer recognizes the three-dimensional image three-dimensionally in connection with the three-dimensional parameter such as the size of the three-dimensional image, the depth of the three-dimensional image, etc. by means of the three-dimensional recognition ability of each viewer.

### Technical Solution

To achieve the object of the invention, the invention provides a method for measuring recognition warping with respect to 3D image comprising: (a) a step of selecting any one from a plurality of three-dimensional parameters for a scale for recognizing a three-dimensional image in a three-dimensional manner; (b) a step of displaying a test stereoscopic image corresponding to the selected three-dimensional parameter on a screen; (c) a step of displaying, on a screen, a plurality of sample images obtained by varying the value of the selected three-dimensional parameter for the test stereoscopic image; (d) a step of selecting at least one of the plurality of sample images; and (e) a step of performing the steps (b) to (d) at least two times on different test stereoscopic images, and measuring a three-dimensional recognition scale for the selected three-dimensional parameter based on the sample image selected in the step (d).

Here, the step (c) and the step (d) are carried out such that they are displayed on a first monitor and a second monitor.

Also, in the step (c), the plurality of sample images are displayed as a 3D image.

Further, during the step (e), a step of displaying one sample image from the plurality of sample images displayed in the step (c) to be the same as the test stereoscopic image is performed at least one time.

Moreover, the 3D parameter comprises at least one of a shape warping parameter, a size warping parameter and a depth warping parameter; when the shape warping parameter is selected in the step (a), the following steps are performed prior to the steps (b) to (e): (a1) a step of displaying a basic stereoscopic image on the screen; (a2) a step of displaying the basic three-dimensional image two-dimensionally and of displaying a plurality of basic sample images obtained by varying values of the shape warping parameter on the screen; and (a3) a step of selecting any one of the plurality of basic sample images; and the value of the three-dimensional parameter in the step (c) is varied based on the value of the shape warping parameter applied to the basic sample images selected in the step (a3) and then is applied to the warping of the test stereoscopic image.

### Advantageous Effect

According to the invention, a method for measuring whether a viewer distortedly recognizes a three-dimensional image or the degree to which a viewer recognizes the three-dimensional image three-dimensionally in connection with the three-dimensional parameter such as the size of the three-dimensional image, the depth of the three-dimensional image, etc. by means of the three-dimensional recognition ability of each viewer is provided.

### BRIEF DESCRIPTION OF THE DRAWINGS

FIG. 1 illustrates a system for measuring recognition warping about 3D image according to the present invention.

FIG. 2 illustrates exemplary elements of the measuring system of FIG. 1.

FIG. 3 illustrates a method for measuring recognition warping about 3D image according to the present invention.

FIGS. 4A-B and FIGS. 5A-B illustrate examples of the test stereoscopic images and a plurality of sample images according to the present invention.

FIG. 6 illustrates a method for measuring recognition warping about 3D image according to another embodiment of the present invention.

FIG. 7 explains the principle to form a warped sample image.

FIGS. 8 and 9 illustrate examples of the test stereoscopic images and a plurality of warped sample images which are applied to the measuring method of FIG. 6.

### BEST MODE FOR CARRYING OUT THE INVENTION

Hereinafter, preferred embodiments will be explained in detail referring to attached drawings.

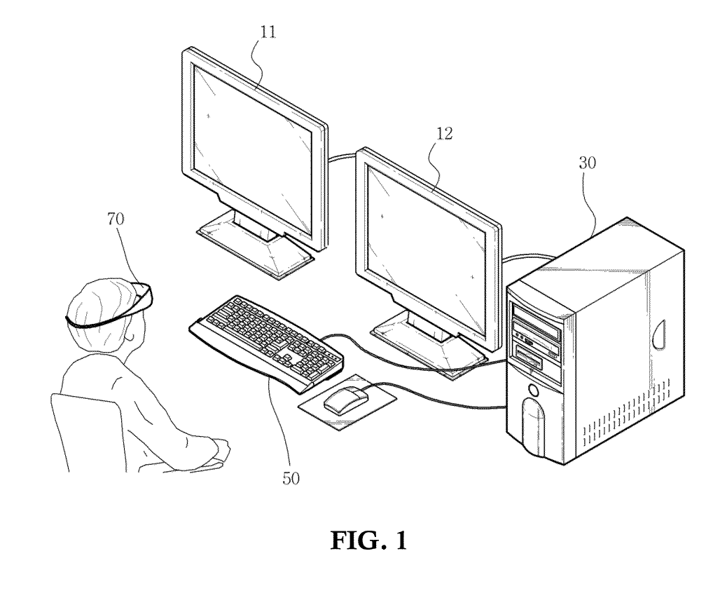

FIG. 1 shows a system for measuring recognition warping about 3D image according to the present invention. As shown in FIG. 1, the measuring system comprises the first monitor 10, the second monitor 11, a measuring device 30 and a user input 50.

The first monitor 10 displays a 3D image which is provided by the measuring device 30 on the screen and the second monitor 11 also displays a 3D image or a 2D image which is provided by the measuring device 30 on the screen.

The measuring device 30 allows a 3D image or a 2D image to be displayed on the first monitor 10 and the second monitor 11 based on signals which are input from the user input 50. Also, the measuring device 30 measures the degree to which a viewer recognizes a warping about 3D image by means of the measuring method which will be explained hereinafter. That is, the measuring device measures the degree to which a viewer recognizes distortedly a 3D image, such as a shape warping, a depth warping and a size warping, when a viewer recognizes a 3D image.

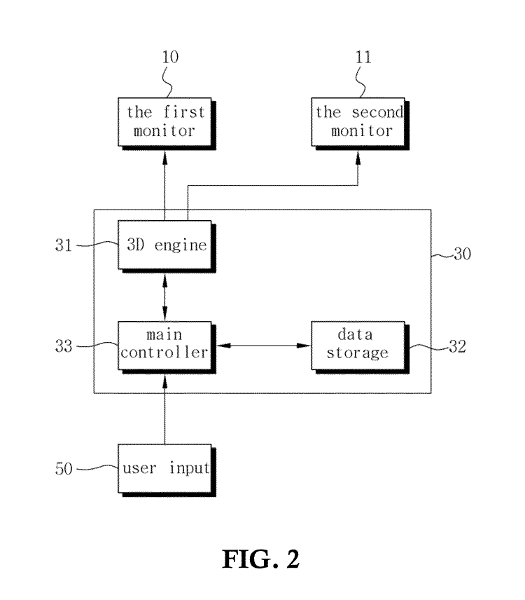

FIG. 2 shows an example of the elements of the measuring system according to the present invention. As shown in FIG. 2, the measuring device 30 comprises a 3D engine 31 for displaying 3D image on the first monitor 10 and/or the second monitor 11 and data storage 32 for storing data of images to be displayed on the first monitor 10 and the second monitor 11.

Further, the measuring device 30 comprises a main controller 33 which controls the 3D engine 31 such that 3D images stored in the data storage 32 are displayed on the first monitor 10 and the second monitor 11 by the 3D engine 31 according to the viewer's manipulation through the user input 50. According to the measuring method which will be described hereinafter, the main controller 33 measures the degree to which a viewer recognizes distortedly a 3D image, i.e., the degree to which a viewer recognizes distortedly an actually-displayed 3D image, such as a shape warping, a depth warping and a size warping, when a viewer recognizes a 3D image three-dimensionally.

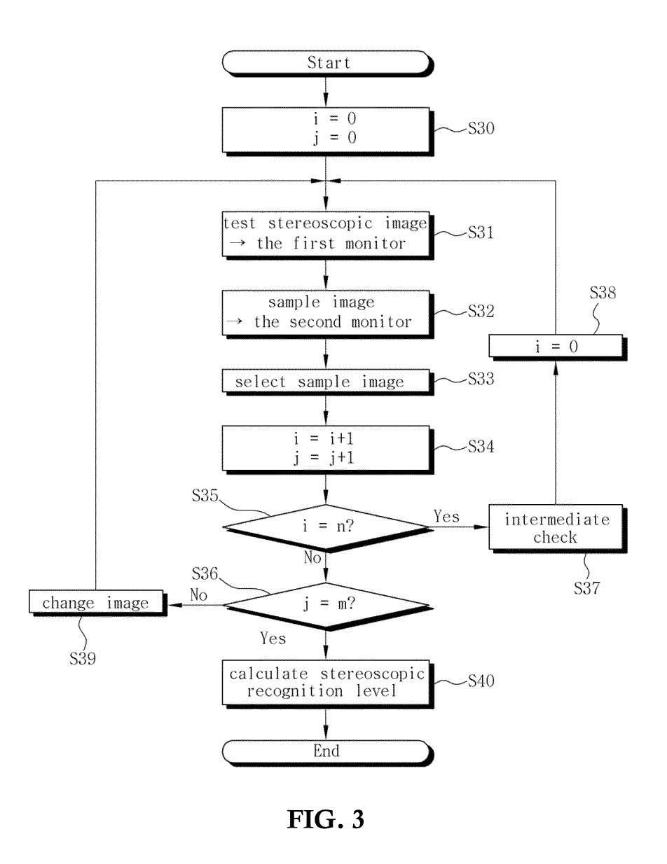

Hereinafter, referring to FIG. 3, a method for measuring recognition warping about a 3D image according to the present invention will be described in detail. Here, in one example, 3D parameters for recognition warping measured by the measuring method of the present invention comprise a shape warping parameter, a size warping parameter and a depth warping parameter.

When a viewer selects a 3D parameter for the measurement by the user input (50), a 3D image for the measurement of the recognition warping about the corresponding 3D parameter is prepared.

When the 3D parameter is selected as above, variables i and j for the measurement are initialized to be ‘0’ (S30). The meaning of i and j will be described hereinafter.

Then, a test stereoscopic image corresponding to the selected 3D parameter is displayed on the screen of the first monitor 10 (S31). A plurality of sample images corresponding to the test stereoscopic image are displayed on the screen of the second monitor 11 (S32).

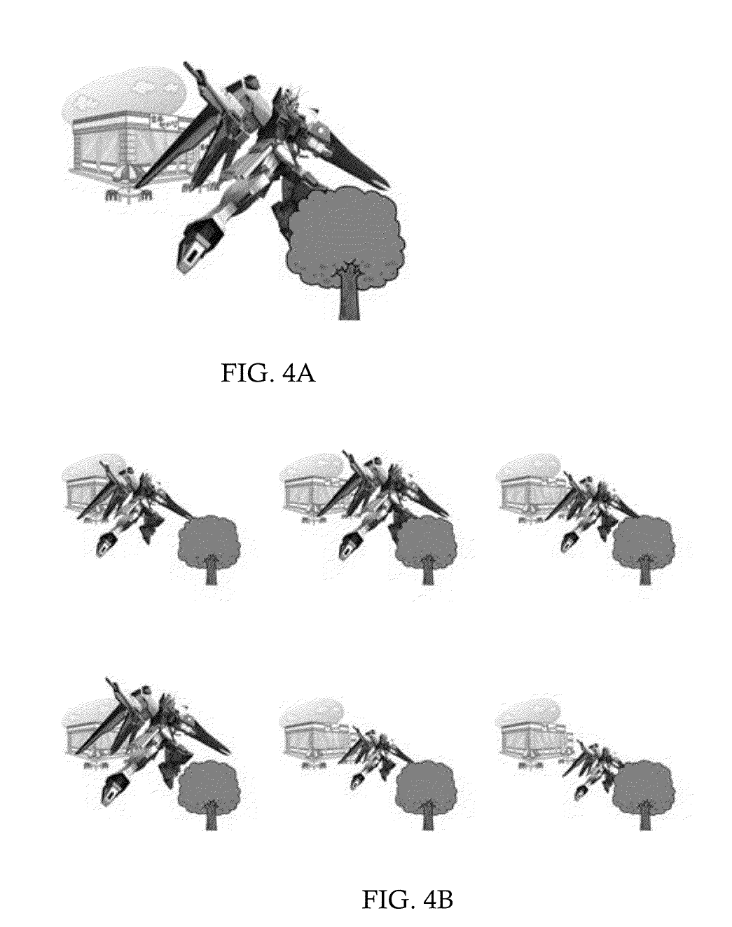

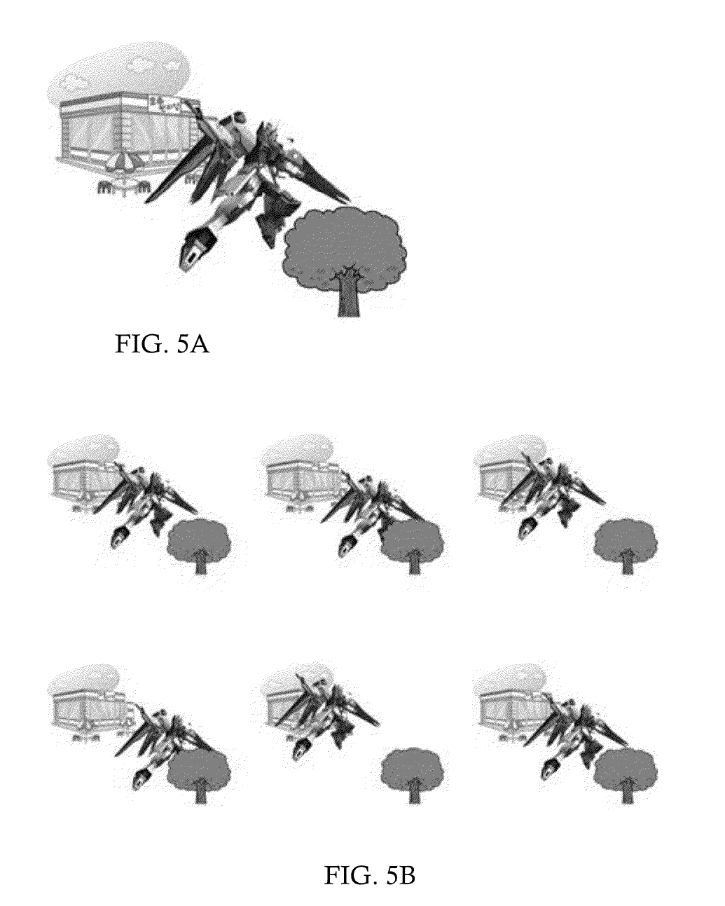

Here, a plurality of sample images are prepared by varying the values of 3D parameter of the test stereoscopic image. FIGS. 4A-B shows examples of the test stereoscopic images and sample images for measuring recognition warping with regard to size warping parameter among 3D parameters. FIGS. 5A-B shows examples of the test stereoscopic images and sample images for measuring recognition warping with regard to depth warping parameter among 3D parameters.

Referring to FIGS. 4A-B, the test stereoscopic image for the size warping parameter consists of two stereoscopic simulations which are expressed as a 3D image having a predetermined size and depth, respectively. In the sample image, one of the two 3D simulations is varied in size while the other is maintained to have the same size.

Referring to FIGS. 5A-B, the test stereoscopic image for the depth warping parameter consists of three stereoscopic simulations which are expressed as a 3D image having predetermined depth, respectively. In the sample image, one 3D simulation is varied in depth between the other two stereoscopic simulations.

As described above, when the test stereoscopic image and the plurality of sample images are displayed on the first monitor 10 and the second monitor 11, respectively, a viewer wears 3D glasses 70, i.e., polarizing glasses, and watches the images to compare the test stereoscopic image and the plurality of sample images and to select at least one sample image which is recognized to be the same as or similar to the test stereoscopic image from the plurality of sample images (S33).

The sample image as described above is formed by the variation of a value of a 3D parameter with respect to the test stereoscopic image. The sample image is obtained by warping the test stereoscopic image. To the degree of warping which is applied to the sample image which a viewer regards as the same as or very similar to the test stereoscopic image from the sample images, a viewer recognizes distortedly the 3D image with regard to the corresponding 3D parameter.

To increase the accuracy of the measurement, the measurement is repeated by a predetermined number of times with regard to the other test stereoscopic image and sample images. In more detail, referring to FIG. 3, if the selection of the sample image is completed in the step S33, the number of times for the measurement is reflected by increasing the variables i and j by 1 (S34).

Then, it is determined whether the number of times for the measurement is n by using the variable i (S35). Here, if n times, i.e., 3 times, of the measurements are completed, the intermediate check is carried out (S37). Here, the intermediate check is carried out in the same way as the steps S31 to S33. By replacing one of the sample images displayed at the step S32 with the same image as the test stereoscopic image and then checking whether a viewer selects the corresponding image, it can be determined whether a viewer selects the same or similar sample image correctly. Then, if the intermediate check is completed, the variable i is initialized to be ‘0’ (S38) so that the next intermediate check after the three times of the measurements is proceeded.

For the plurality of the measurement, in the step S36, it is determined whether the number of times for the measurement is m by using the variable j. If the measurements are not carried out m times, the test stereoscopic image and the sample images are replaced with images which are different from the images of FIGS. 4A-B or FIGS. 5A-B (S39), and then the steps S31 to S36 are repeated, as described above.

In one example, in case that the measurements are carried out 10 times, an average for a value of 3D parameter applied to the sample images selected by the viewer at each measuring step is obtained and the use of the average allows a stereoscopic recognition level indicating the degree to which a viewer recognizes distortedly the image with regard to the corresponding 3D parameter to be calculated (S40). The above process is applied to each of 3D parameters and a stereoscopic recognition level is calculated with regard to each 3D parameter.

In the above example, as shown FIGS. 4A-B and 5A-B, a size warping parameter and a depth warping parameter are selected from 3D parameters. But, it should be understood that the same method can be applied to a shape warping parameter. Moreover, the above method can be applied to other 3D parameters, such as color of 3D image or displacement of 3D image.

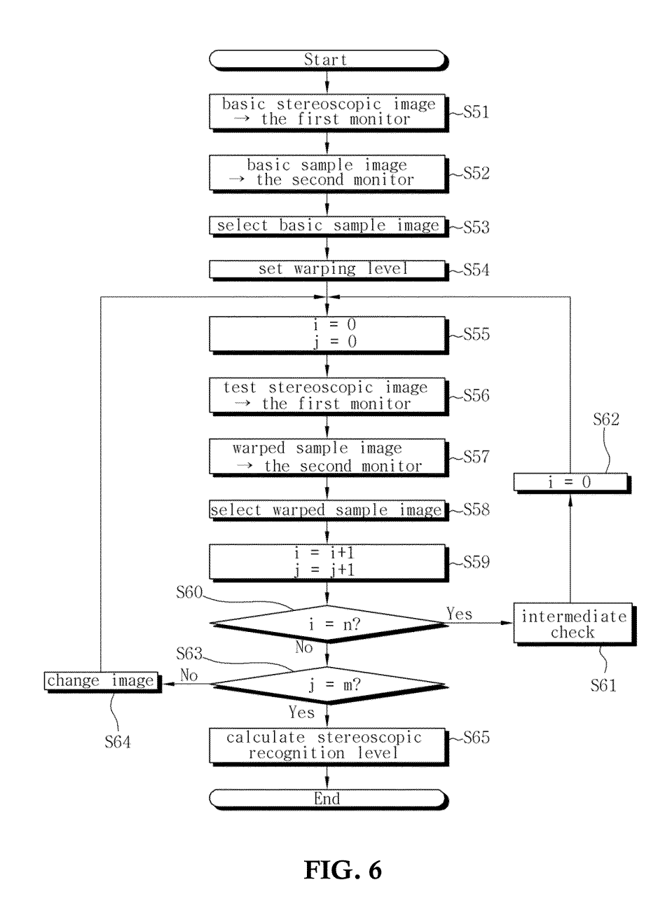

Hereinafter, referring to FIGS. 6 to 9, a method for measuring recognition warping about 3D image according to another embodiment of the present invention will be described in detail. Here, the measuring method according to another embodiment will use a method for measuring recognition warping according to the variation of the shape warping parameter among 3D parameters.

Referring to FIG. 6, a basic stereoscopic image is displayed on the first monitor 10 (S51) and a plurality of basic sample images are displayed on the second monitor 11 (S52). Here, the basic stereoscopic image displayed on the first monitor 10 is a basic image such as a three-dimensional rectangular parallelepiped, not a specific target image.

The basic sample images are two-dimensional rectangular parallelepiped which can be recognized according to the change of the shape warping parameter when a three-dimensional rectangular parallelepiped is viewed by eyes of a viewer. That is, the basic sample image is an image displayed two-dimensionally from the basic 3D image and in particular a 2D image displayed from the stereoscopic 3D image when the shape warping parameter is varied.

When the stereoscopic 3D image and the plurality of basic sample images are displayed on the first monitor 10 and the second monitor 11, respectively, as described above, a viewer wears 3D glasses 70, i.e., polarizing glasses, and watches the stereoscopic 3D image. Then, the viewer takes off the 3D glasses 70 and selects, among the plurality of the basic sample images, one image which is recognized to be the same as the stereoscopic 3D image when viewed with the 3D glasses.

Here, the shape warping parameter which is applied to the basic sample image selected from the basic sample images by a viewer will be the warping level of the recognition warping which is recognized with respect to the shape warping parameter when the viewer watches a 3D image. For the post-measurement, the above warping level is set for the present viewer (S54).

As explained above, if the establishment of the warping level is finished, the variables i and j for the measurement are initialized to be ‘0’ (S55). Then, a test stereoscopic image is displayed on the screen of the first monitor 10 to measure the recognition warping with regard to the shape warping parameter (S56). Then, the plurality of warping sample images corresponding to the test stereoscopic image are displayed on the screen of the second monitor 11 (S57).

Here, a plurality of warping sample images are formed from the test stereoscopic image by varying the value of the shape warping parameter. The value of the shape warping parameter applied to the plurality of the warping sample images are determined by the warping level set by the above method, i.e., by the value of the shape warping parameter which is applied to the basic sample image selected by a viewer.

In one example, if the warping level is high, the value of the shape warping parameter applied to the warping sample image is set to be high and thus a warping sample image having a relatively-high shape warping is displayed. On the contrary, if the warping level is low, the value of the shape warping parameter applied to the warping sample image is set to be low and thus a warping sample image having a relatively-low shape warping is displayed. Therefore, the variance of the degree of the shape warping of the warping sample image according to the degree to which a viewer recognizes the shape warping when the viewer watches 3D image will allow the degree of shape warping recognition to be measured more accurately.

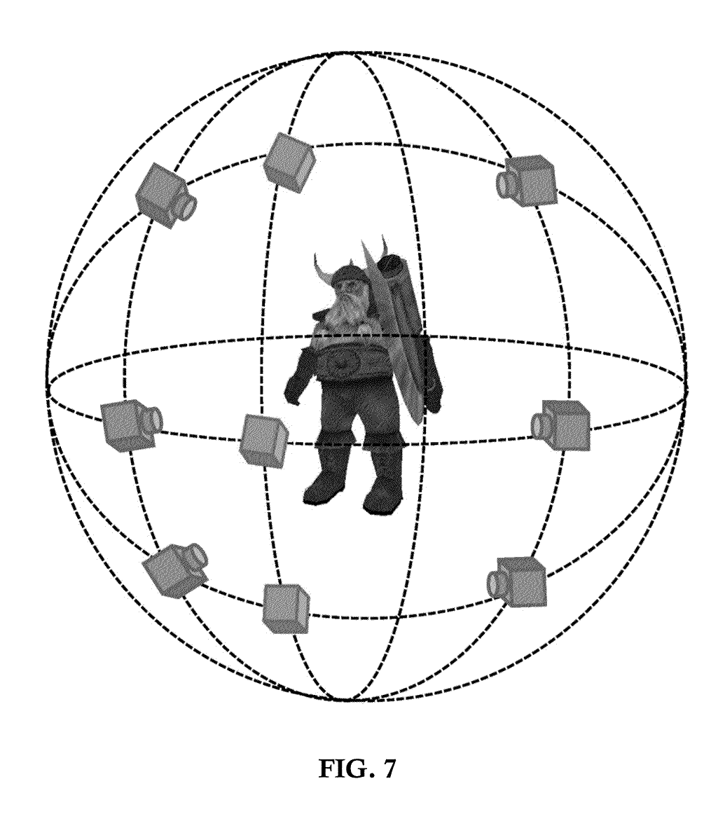

FIG. 7 shows a principle to generate a warped sample image. As shown in FIG. 1, a 3D image will be seen differently according to the view orientation. A viewer recognizes a shape warping in a manner that a viewer watches the same 3D image with different viewing direction.

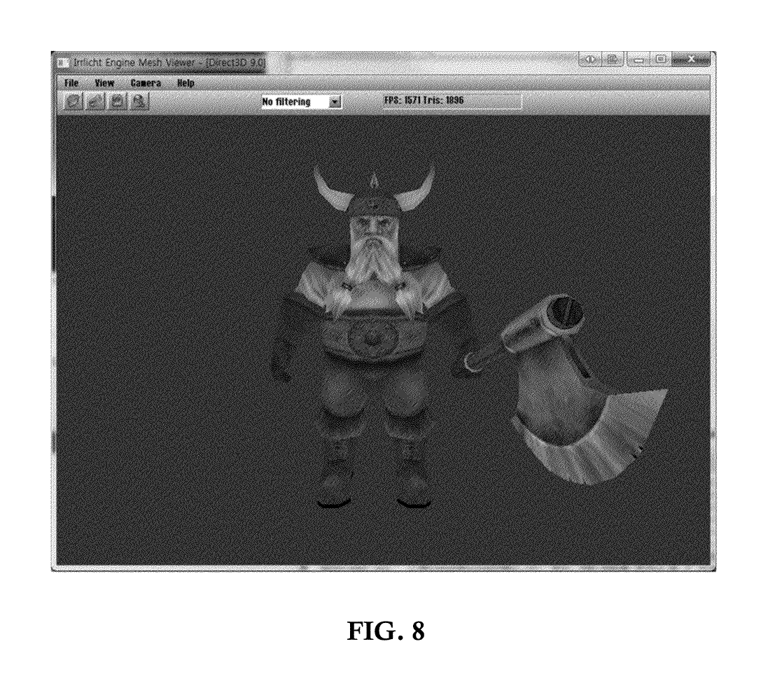

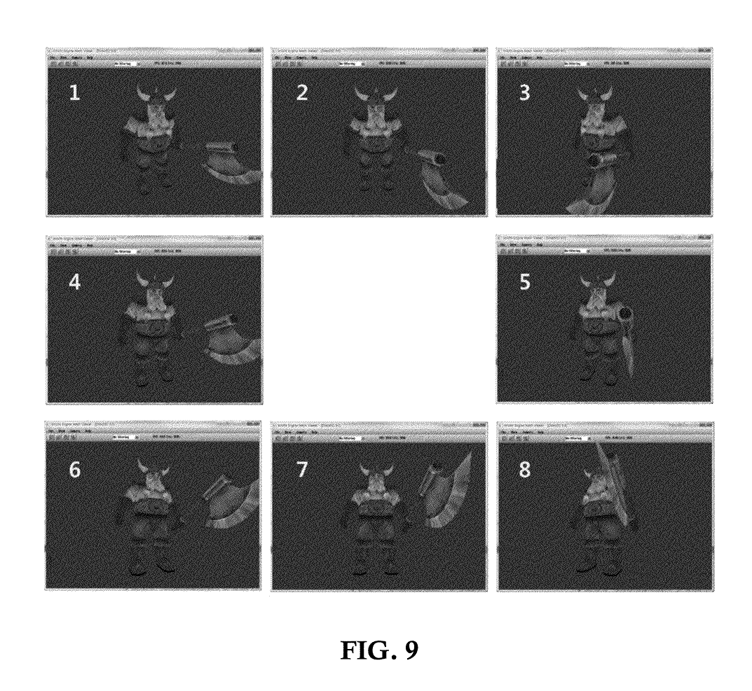

To reflect the shape warping according to the viewer, as shown FIGS. 8 and 9, the test stereoscopic image and a plurality of warping sample images are displayed on the first monitor 10 and the second monitor 11, respectively. FIG. 8 is a test stereoscopic image and FIG. 9 is a plurality of warping sample images.

As described above, when the test stereoscopic image and the plurality of sample images are displayed on the first monitor 10 and the second monitor 11, respectively, a viewer wears 3D glasses 70 and compares the test stereoscopic image and the plurality of sample images and to select at least one warping sample image which is recognized to be the same as or similar to the test stereoscopic image from the plurality of warping sample images (S58).

To increase the accuracy of the measurement, the measurement is repeated by a predetermined number of times with regard to the other test stereoscopic image and sample images. Referring to FIG. 6, if the selection of the sample image is completed in the step S58, the number of times for the measurement is reflected by increasing the variables i and j by 1 (S59).

Then, it is determined whether the number of times for the measurement is n by using the variable i (S60). Here, if n times, i.e., 3 times, of the measurements are completed, the intermediate check is carried out (S61). Here, the intermediate check is carried out in the same way as the steps S56 to S58. By replacing one of the warping sample images displayed at the step S57 with the same image as the test stereoscopic image and then checking whether a viewer selects the corresponding image, it can be determined whether a viewer selects the same or similar sample image correctly. Then, if the intermediate check is completed, the variable i is initialized to be ‘0’ (S62) so that the next intermediate check after the three times of the measurements is proceeded.

For the plurality of the measurement, in the step S63, it is determined whether the number of times for the measurement is m by using the variable j. If the measurements are not carried out m times, the test stereoscopic image and the warping sample images are replaced with images which are different from the images of FIG. 8 or FIG. 9 (S64), and then the steps S56 to S63 are repeated, as described above.

In one example, in case that the measurements are carried out 10 times, an average for values of the shape warping parameter, i.e., an average for the values of 3D parameters applied to the warping sample images selected by the viewer at each measuring step is obtained and the use of the average allows a stereoscopic recognition level indicating the degree to which a viewer recognizes distortedly the image with regard to the shape warping parameter to be calculated. The above process is applied to each of 3D parameters and a stereoscopic recognition level is calculated with regard to each 3D parameter (S65).

It is intended that the foregoing description has described only a few of the many possible implementations of the present invention, and that variations or modifications of the embodiments apparent to those skilled in the art are embraced within the scope and spirit of the invention. The scope of the invention is determined by the claims and their equivalents.

### INDUSTRIAL APPLICABILITY

The present invention relates to a method for measuring recognition warping about 3D image and in particular to a method for determining whether a viewer recognizes distortedly three-dimensional image or for determining the degree to which a viewer recognizes the three-dimensional image three-dimensionally with regard to the three-dimensional parameter such as the size of the three-dimensional image, the depth of the three-dimensional image, etc.

1. A method for measuring recognition warping with respect to a three-dimensional (3D) image comprising:
(a) a step of selecting any one from a plurality of 3D parameters for a scale for recognizing a 3D image in a 3D manner;
(b) a step of displaying a test stereoscopic image corresponding to the selected 3D parameter on a screen;
(c) a step of displaying, on a screen, a plurality of sample images obtained by varying the value of the selected 3D parameter for the test stereoscopic image;
(d) a step of selecting at least one of the plurality of sample images; and
(e) a step of performing the steps (b) to (d) at least two times on different test stereoscopic images, and measuring a 3D recognition scale for the selected 3D parameter based on the sample image selected in the step (d).

2. The method according to claim 1, wherein the step (c) and the step (d) are carried out such that they are displayed on a first monitor and a second monitor.

3. The method according to claim 1, wherein in the step (c), the plurality of sample images are displayed as a 3D image.

4. The method according to claim 1, wherein during the step (e), a step of displaying one sample image from the plurality of sample images displayed in the step (c) to be the same as the test stereoscopic image is performed at least one time.

5. The method according to claim 1, wherein the 3D parameter comprises at least one of a shape warping parameter, a size warping parameter and a depth warping parameter, wherein when the shape warping parameter is selected in the step (a), the following steps are performed prior to the steps (b) to (e):
(a1) a step of displaying a basic stereoscopic image on the screen;
(a2) a step of displaying the basic 3D image two-dimensionally and of displaying a plurality of basic sample images obtained by varying values of the shape warping parameter on the screen; and
(a3) a step of selecting any one of the plurality of basic sample images; and
wherein the value of the 3D parameter in the step (c) is varied based on the value of the shape warping parameter applied to the basic sample images selected in the step (a3) and then is applied to the warping of the test stereoscopic image.

6. The method according to claim 2, wherein the 3D parameter comprises at least one of a shape warping parameter, a size warping parameter and a depth warping parameter, wherein when the shape warping parameter is selected in the step (a), the following steps are performed prior to the steps (b) to (e):
(a1) a step of displaying a basic stereoscopic image on the screen;
(a2) a step of displaying the basic 3D image two-dimensionally and of displaying a plurality of basic sample images obtained by varying values of the shape warping parameter on the screen; and
(a3) a step of selecting any one of the plurality of basic sample images; and
wherein the value of the 3D parameter in the step (c) is varied based on the value of the shape warping parameter applied to the basic sample images selected in the step (a3) and then is applied to the warping of the test stereoscopic image.

7. The method according to claim 3, wherein the 3D parameter comprises at least one of a shape warping parameter, a size warping parameter and a depth warping parameter, wherein when the shape warping parameter is selected in the step (a), the following steps are performed prior to the steps (b) to (e):
(a1) a step of displaying a basic stereoscopic image on the screen;
(a2) a step of displaying the basic 3D image two-dimensionally and of displaying a plurality of basic sample images obtained by varying values of the shape warping parameter on the screen; and
(a3) a step of selecting any one of the plurality of basic sample images; and
wherein the value of the 3D parameter in the step (c) is varied based on the value of the shape warping parameter applied to the basic sample images selected in the step (a3) and then is applied to the warping of the test stereoscopic image.

8. The method according to claim 4, wherein the 3D parameter comprises at least one of a shape warping parameter, a size warping parameter and a depth warping parameter, wherein when the shape warping parameter is selected in the step (a), the following steps are performed prior to the steps (b) to (e):
(a1) a step of displaying a basic stereoscopic image on the screen;
(a2) a step of displaying the basic 3D image two-dimensionally and of displaying a plurality of basic sample images obtained by varying values of the shape warping parameter on the screen; and
(a3) a step of selecting any one of the plurality of basic sample images; and
wherein the value of the 3D parameter in the step (c) is varied based on the value of the shape warping parameter applied to the basic sample images selected in the step (a3) and then is applied to the warping of the test stereoscopic image.
